(19) United States
(12) Patent Application Publication
(10) Pub. No.: US 2018/0314893 A1
(43) Pub. Date: Nov. 1, 2018

(54) INFORMATION PROCESSING DEVICE, VIDEO IMAGE MONITORING SYSTEM, INFORMATION PROCESSING METHOD, AND RECORDING MEDIUM

(71) Applicant: CANON KABUSHIKI KAISHA, Tokyo (JP)

(72) Inventor: Kenji Tsukamoto, Tokyo (JP)

(21) Appl. No.: 15/954,363

(22) Filed: Apr. 16, 2018

(30) Foreign Application Priority Data
Apr. 26, 2017 (JP) 2017-087205

(51) Int. Cl. G06K 9/00; G06T 7/246; G06T 7/292

(52) U.S. Cl. CPC G06K 9/00711; G06K 9/00771; G06T 7/248; G06T 2207/30232; G06T 2207/10016; G06T 2207/30196; G06T 7/292

(57) ABSTRACT

One or more information processing apparatuses, systems, methods and recording or storage mediums are provided herein. When tracking a subject between monitoring cameras, if the subject being tracked goes out of a first imaging range, detection content of an external camera is acquired and identification processing is performed, and then information of the subject is transmitted to an outside on a basis of a result of the identification processing.

### BACKGROUND OF THE INVENTION

### Field of the Invention

The present disclosure relates to at least one embodiment of an information processing device, a video image monitoring system, an information processing method, and a recording medium.

### Description of the Related Art

A monitoring system is proposed that detects an object by using a plurality of monitoring cameras installed in a monitoring space, identifies the object between the cameras, and tracks the object. In Japanese Patent No. 4700477, a method is proposed that detects a subject in a video image of a monitoring camera located in a monitoring space, calculates a feature amount, identifies the subject between cameras on the basis of the obtained feature amount, and tracks the subject.

However, in the monitoring system of Japanese Patent No. 4700477, it is assumed that the subject is tracked in one monitoring space, so that if the subject moves to another monitoring space, another video image monitoring system detects and identifies the subject and tracks the subject. Therefore, the subject may be tracked by transmitting information of the subject being tracked in a certain video image monitoring system to another video image monitoring system. However, in this case, it is necessary to transmit information of a detected subject to outside. However, it takes a large communication cost to transmit a tracking result and subject information to unspecified external monitoring systems.

### SUMMARY OF THE INVENTION

At least one embodiment of an information processing device includes a detection unit that detects a subject on a captured image that is acquired from at least one or more image capturing units, an acquisition unit that acquires feature information corresponding to a subject detected by an external device from the external device when the subject being detected by the detection unit becomes undetected on a captured image that is newly acquired by the at least one or more image capturing units, an identification unit that identifies that the subject detected by the detection unit is the subject indicated by the feature information acquired by the acquisition unit; and a transmission unit that transmits information indicating a feature of the subject identified by the identification unit to the external device.

According to other aspects of the present disclosure, one or more additional information processing devices, one or more video image monitoring systems, one or more information processing methods, and one or more recording mediums for use therewith are discussed herein. Further features of the present disclosure will become apparent from the following description of exemplary embodiments (with reference to the attached drawings).

### BRIEF DESCRIPTION OF THE DRAWINGS

FIG. 1 is a diagram showing an example of a hardware configuration of a video image monitoring system.

FIG. 2 is a diagram showing an example of a functional configuration and the like of the video image monitoring system.

FIG. 3 is a diagram showing an example where video image monitoring is performed in each monitoring space.

FIG. 4 is a diagram showing an example of subject information registered in a subject DB.

FIGS. 5A to 5D are diagrams showing an example of statistic information.

FIG. 6 is a diagram showing an example of the subject information.

FIGS. 7A to 7C are flowcharts showing one or more examples of information processing.

FIG. 8 is a diagram showing an example of appearance probabilities.

### DESCRIPTION OF THE EMBODIMENTS

Hereinafter, embodiments of the present disclosure will be described with reference to the drawings.

### First Embodiment

A video image monitoring system according to the present embodiment detects a human figure in a video image of a monitoring camera, identifies the human figure by extracting a feature amount of the detected human figure and comparing the feature amount with a feature amount of a human figure detected in a video image of another monitoring camera, and tracks the subject between monitoring cameras. When the subject being tracked goes out of a monitoring space of the video image monitoring system, the video image monitoring system acquires statistic information from an external video image monitoring system, selects subject information similar to the statistic information, and transmits the subject information to the external video image monitoring system. The external video image monitoring system identifies the human figure by using the acquired feature amount of the human figure and continues the tracking.

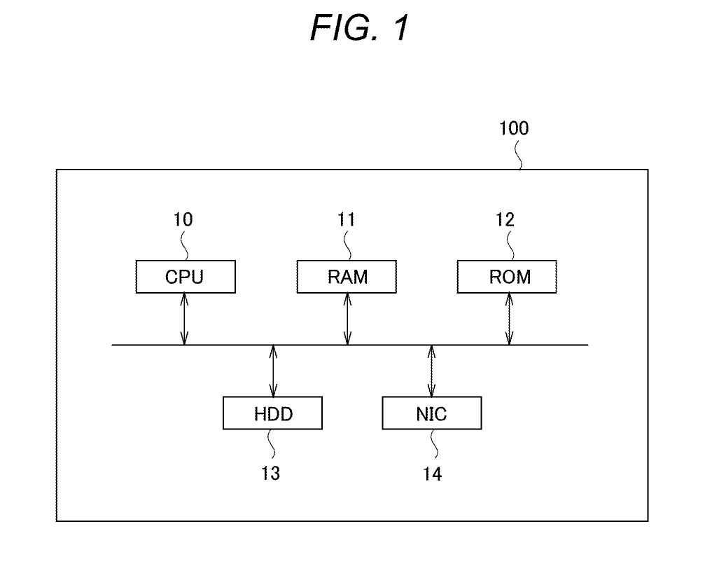

FIG. 1 is a diagram showing an example of a hardware configuration of a video image monitoring system 100. The video image monitoring system 100 includes various units (10 to 14). A CPU (Central Processing Unit) 10 is a unit that executes various programs and realizes various functions. A RAM (Random Access Memory) 11 is a unit that stores various information. The RAM 11 is also a unit that is used as a temporary work storage area of the CPU 10. The ROM (Read Only Memory) 12 is a unit that stores various programs and the like. For example, the CPU 10 loads a program stored in the ROM 12 into the RAM 11 and executes the program.

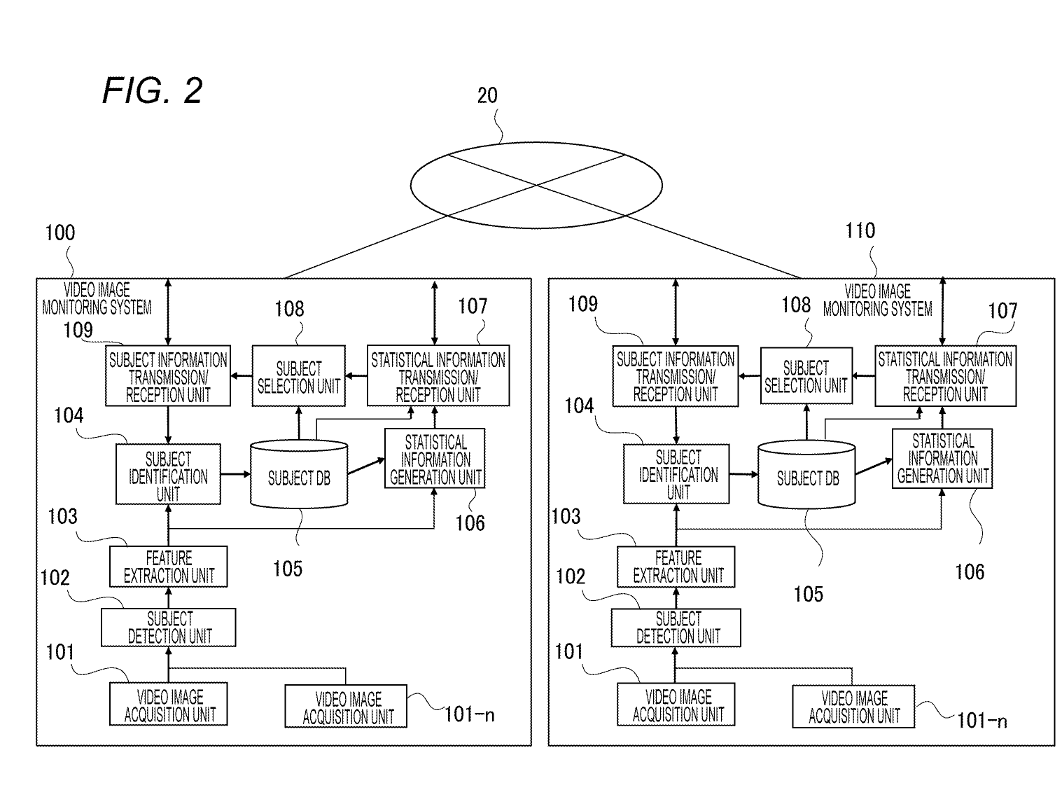

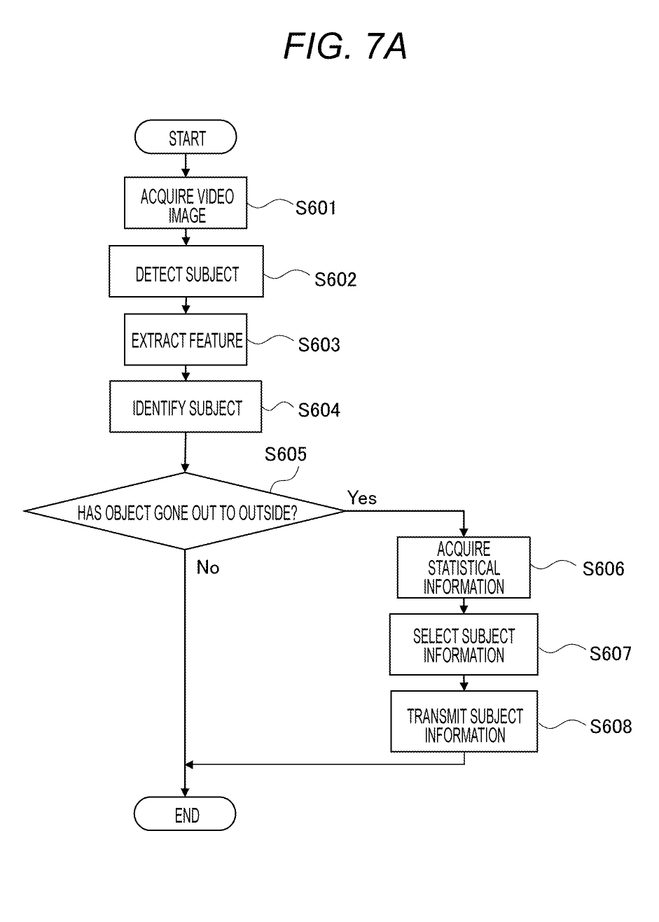

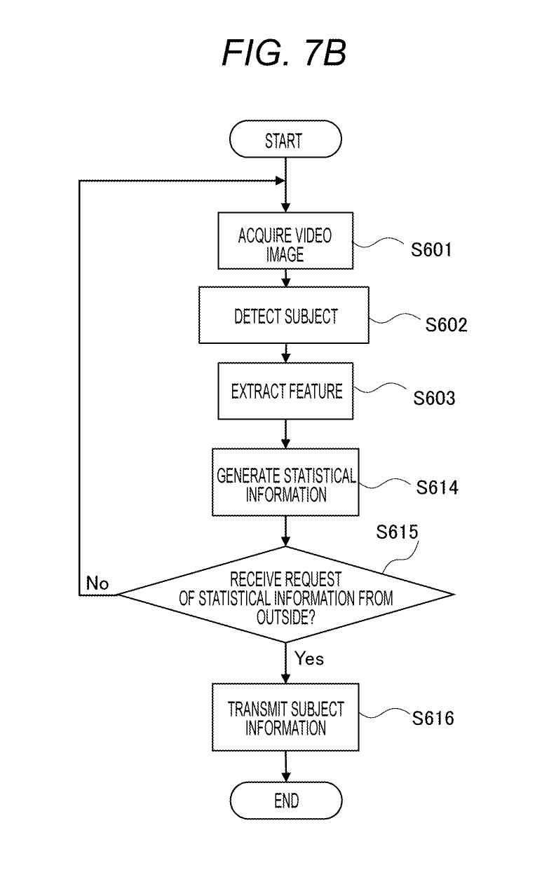

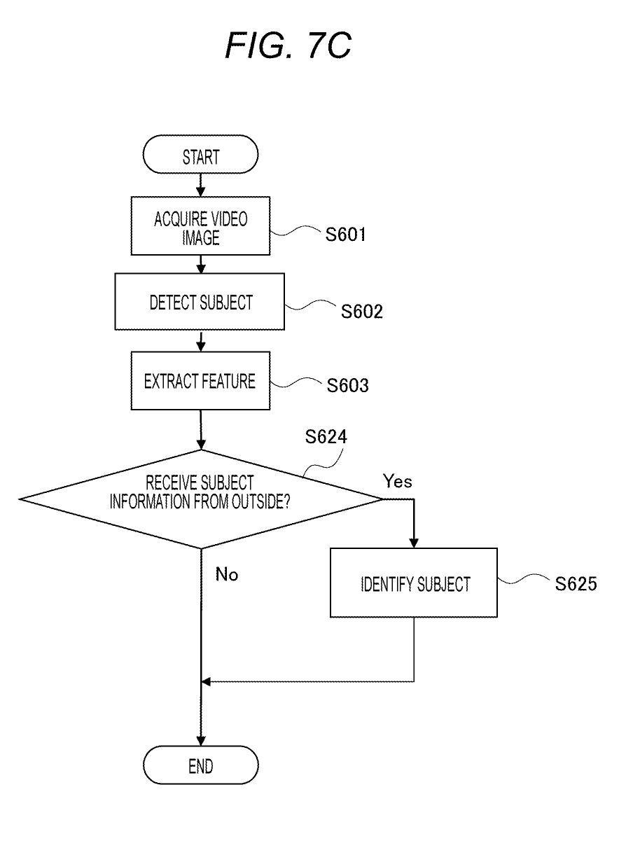

In addition, the CPU 10 performs processing on the basis of a program stored in an external storage device such as a flash memory, an HDD (Hard Disk Drive), or an SSD (Solid State Disk). Thereby, a software configuration that configures the video image monitoring system 100 or the video image monitoring system 110 as shown in FIG. 2 and each step of one or a plurality of flowcharts of FIGS. 7A to 7C described later are realized.

All or part of functions of the video image monitoring system 100 and the video image monitoring system 110 and processing of steps of the flowcharts of FIGS. 7A to 7C described later may be realized by using dedicated hardware.

A NIC (Network Interface Card) 205 is a unit for connecting the video image monitoring system 100 to a network.

The video image monitoring system 100 may be realized by one device or computer as shown in FIG. 1 or may be realized by a plurality of devices or computers.

FIG. 2 is a diagram showing an example of a functional configuration and the like of the video image monitoring system. In the present embodiment, a case in which subject information is transmitted from the video image monitoring system 100 to the video image monitoring system 110 will be described. As shown in FIG. 2, a system of the present embodiment includes the video image monitoring system 100 and the video image monitoring system 110, and the video image monitoring system 100 and the video image monitoring system 110 are communicably connected through a network 20.

As the video image monitoring system 100 and the video image monitoring system 110 have substantially the same configuration, any overlapped detailed description of items of the configuration will be omitted.

The video image monitoring system 100 and the video image monitoring system 110 includes video image acquisition units 101, a subject detection unit 102, a feature extraction unit 103, a subject identification unit 104, a subject data base (subject DB) 105, and a statistic information generation unit 106 as a functional configuration. Further, the video image monitoring system 100 and the video image monitoring system 110 includes a statistic information transmission/reception unit 107, a subject selection unit 108, and a subject information transmission/reception unit 109 as a functional configuration.

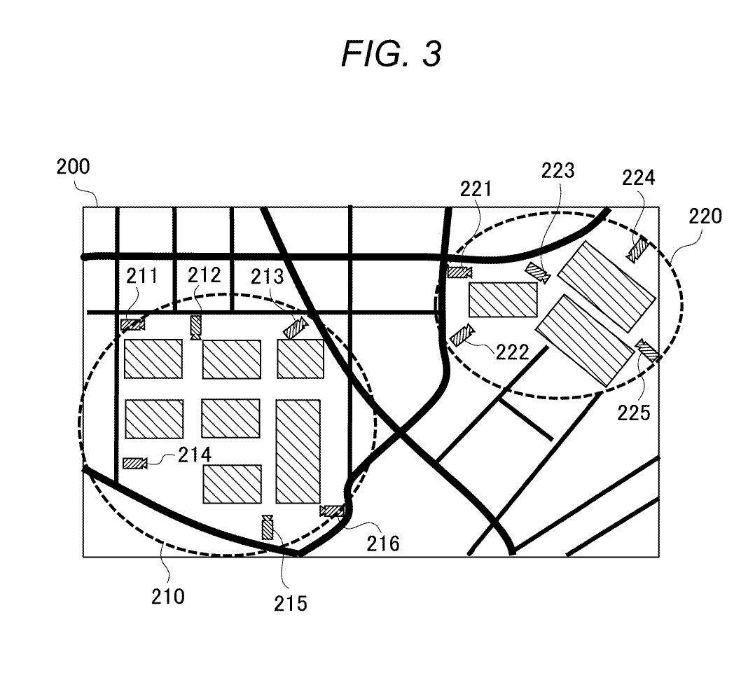

The video image acquisition unit 101 acquires a video image that is imaged by an installed monitoring camera or the like. FIG. 3 shows a situation in which video image monitoring is performed in a monitoring space 210 of the video image monitoring system 100 and a monitoring space 220 of the video image monitoring system 110 in a map 200. In this situation, the video image acquisition units 101 to 101-n of the video image monitoring system 100 correspond to monitoring cameras 211 to 216 and the video image acquisition units 101 to 101-n of the video image monitoring system 110 correspond to monitoring cameras 221 to 225.

A video image imaged by the monitoring camera may be stored in a recorder, and the video image acquisition unit 101 may acquire the stored video image from the recorder. The video image acquisition unit 101 outputs the acquired video image to the subject detection unit 102.

The subject detection unit 102 performs subject detection processing on the acquired video image. The subject detection unit 102 detects a subject by comparing pixel values of a background image prepared in advance and each image captured by photography (captured image), extracting pixel values different from the background image, and connecting adjacent pixels to the extracted pixels.

The subject detection unit 102 can also detect a human figure by performing sliding window processing in which comparison operation is performed while sliding a human figure model prepared in advance with respect to an image by using, for example, a method of Histograms of oriented gradients for human detection, N. Dalal, CVPR2005, comparing each area of the image and the human figure model, and determining whether or not each area of the image is a human figure.

Here, the subject detection unit 102 may detect a human figure by another method, without being limited to the above methods.

The subject detection unit 102 sends an area image of the detected human figure to the feature extraction unit 103.

The feature extraction unit 103 extracts a feature amount from the human figure image detected by the subject detection unit 102. The feature extraction unit 103 normalizes the obtained human figure image into a certain size. The feature extraction unit 103 divides the normalized human figure image into small areas of a predetermined size and generates a color histogram in each small area. The feature extraction unit 103 can extract the feature amount by connecting the color histograms in the small areas to form a vector. The extraction method of the feature amount is not limited to this one. The feature extraction unit 103 may extract the feature amount by using another method.

The feature extraction unit 103 sends feature information including the obtained feature amount of the human figure to the subject identification unit 104.

The subject identification unit 104 compares obtained feature amounts of subjects between different cameras and determines whether or not the subjects are an identical human figure from the similarity of the feature amounts.

For example, the subject identification unit 104 can calculate the similarity by using a cosine similarity shown by the following (Formula 1).

$$\begin{matrix}[ Expression 1 ] & \\ cos ( q , d ) = \frac{{\sum }_{i = 1}^{n} {q}_{i} {d}_{i}}{\sqrt{{\sum }_{i = 1}^{n} {q}_{i}^{2}} \sqrt{{\sum }_{i = 1}^{n} {d}_{i}^{2}}} & ( Formula 1 )\end{matrix}$$

The calculation of the similarity is not limited to the cosine similarity. The subject identification unit 104 may use SSD (Sum of Squared Difference), SAD (Sum of Absolute Difference), or the like, or may calculate another evaluation value. When the calculated similarity has the highest value, the subject identification unit 104 identifies that two human figures being compared are an identical human figure.

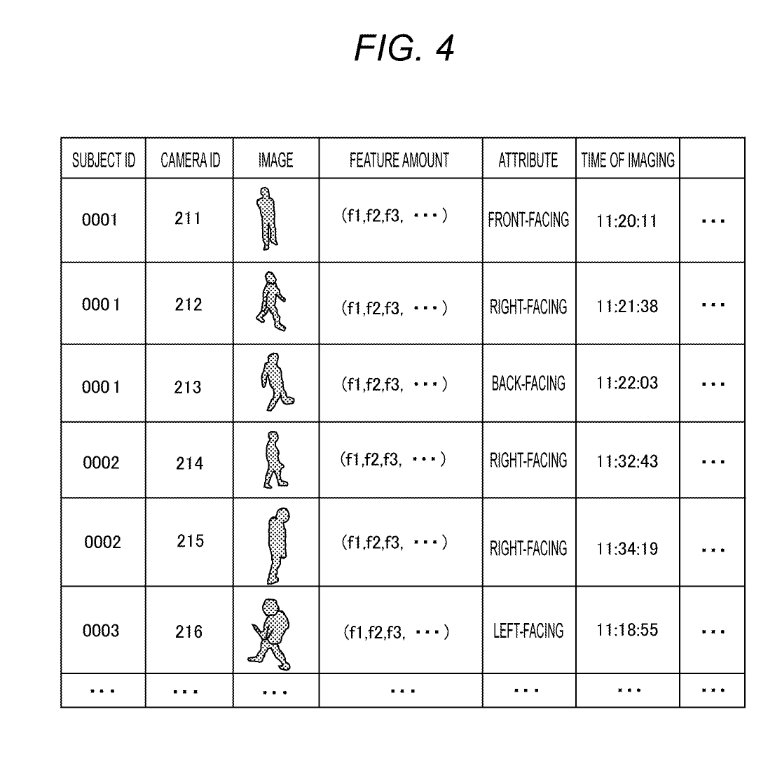

The subject identification unit 104 registers a subject ID, a camera ID, an image, a feature amount, an attribute, position information, and the like of the identified subject into the subject DB 105 as subject information. FIG. 4 is a diagram showing an example of the subject information registered in the subject DB 105. FIG. 4 is an example of the subject information, and the subject information may include gender and age of the subject estimated as the subject information, parameters of a monitoring camera that has acquired a subject image, installation condition and position information of the monitoring camera, and the like, in addition to the information shown in FIG. 4.

The statistic information generation unit 106 generates statistic information related to the subject in the video image.

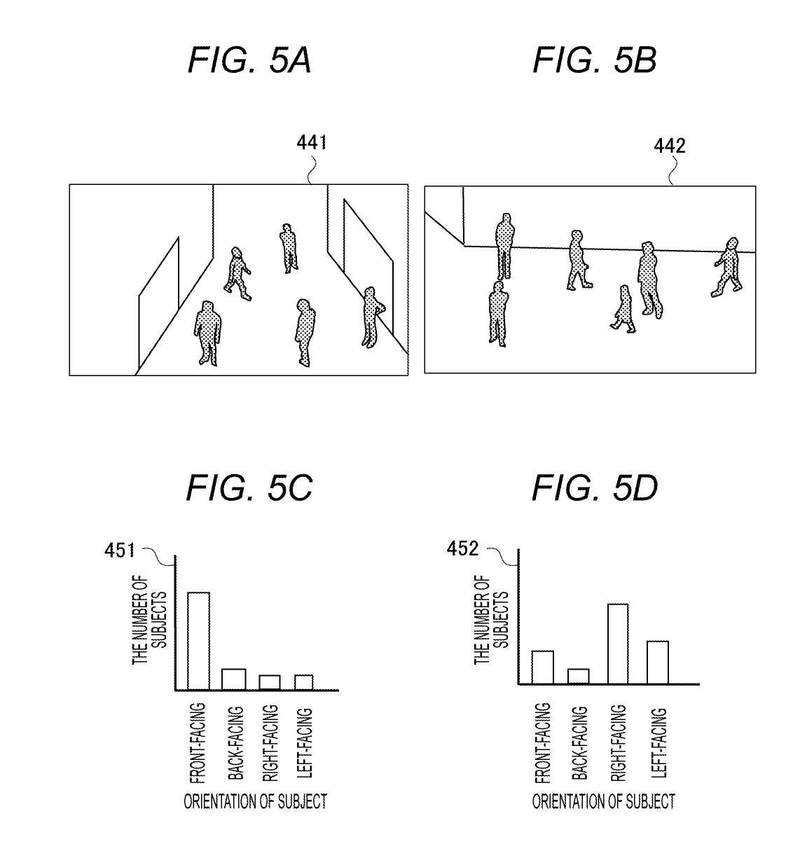

FIGS. 5A to 5D are diagrams showing an example of statistic information 451 and 452 of generation results for each class (front-facing, right-facing, left-facing, or back-facing) of a human figure detected in a video image 441 of a monitoring camera 221 and a video image 442 of a monitoring camera 222. For example, as shown in FIG. 5C, statistic information where the number of detected front-facing subjects are greater than that of detected subjects facing any of the other orientations is obtained from the video image 441 of FIG. 5A. Further, as shown in FIG. 5D, statistic information where the number of detected right-facing subjects are greater than that of detected subjects facing any of the other orientations is obtained from the video image 442 of FIG. 5B. When the statistic information generation unit 106 generates the statistic information on the basis of video images from each monitoring camera, the statistic information generation unit 106 may generate the statistic information by specifying a time zone and the like. Further, the statistic information generation unit 106 may generate statistic information of orientations of subjects for each age and/or statistic information of orientations of subjects for each gender after determining attributes, such as age and gender, by using feature amounts for each subject detection result obtained by the feature extraction unit 103. The statistic information generation unit 106 can acquire the attributes from a comparison result by comparing the feature amount with a model learned by SVM (Support Vector Machine).

The statistic information generation unit 106 outputs the generated statistic information of the monitoring cameras to the statistic information transmission/reception unit 107. Here, the statistic information generation unit 106 may acquire camera parameters, installation condition of the monitoring cameras, and the like and output the camera parameters, the installation condition of the monitoring cameras, and the statistic information to the statistic information transmission/reception unit 107. In the description below, it is assumed that the camera parameters, information indicating the installation condition of the monitoring cameras, and the like are included in the statistic information for simplicity of the description.

For example, when a subject being tracked by the video image monitoring system 100 becomes not detected by the subject detection unit 102, the statistic information transmission/reception unit 107 determines that the subject has gone out of a monitoring space (has gone out of an imaging range) and requests an external video image monitoring system 110 to transmit statistic information. The video image monitoring system 110 transmits statistic information of each monitoring camera generated by the statistic information generation unit 106 on the basis of the request from the video image monitoring system 100 to the video image monitoring system 100. At this time, the video image monitoring system 110 may transmit statistic information of all monitoring cameras of the video image monitoring system 110 or may transmit statistic information of monitoring cameras selected by a user in advance. For example, the CPU 10 may store identification information of monitoring cameras selected through an input/output device or the like into an HDD 13 or the like and transit statistic information of the selected monitoring cameras on the basis of the identification information.

The statistic information transmission/reception unit 107 outputs the received statistic information to the subject selection unit 108.

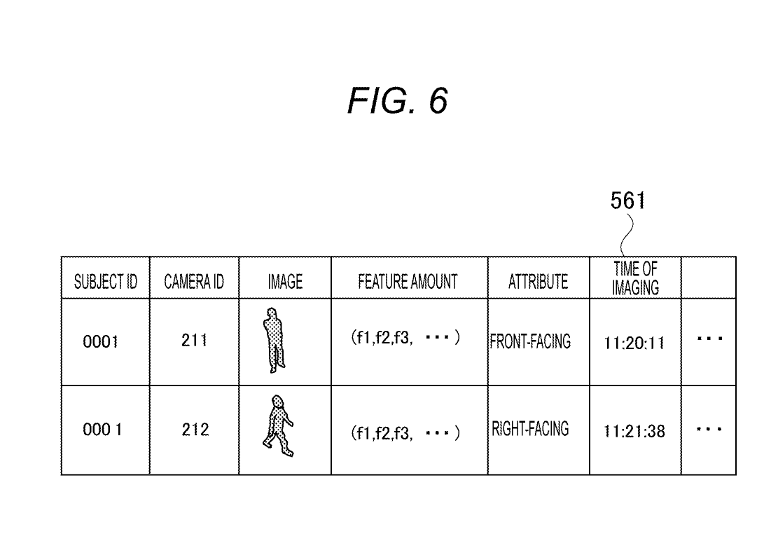

The subject selection unit 108 selects, from the subject DB 105, information of the same attribute in terms of a subject ID being tracked and the statistic information 451 and 452, on the basis of the statistic information 451 and 452 received from the statistic information transmission/reception unit 107. Information 561 shown in FIG. 6 is the selected subject information. The subject selection unit 108 selects front-facing subject information and right-facing subject information whose statistical values are the highest, from the received statistic information 451 and 452. The subject selection unit 108 outputs the selected subject information to the subject information transmission/reception unit 109. The subject selection unit 108 selects subject information according to the statistic information received from the statistic information transmission/reception unit 107. For example, when the subject selection unit 108 receives camera parameters along with the statistic information 451 and 452 from the statistic information transmission/reception unit 107, the subject selection unit 108 selects subject information according to the camera parameters and the statistic information 451 and 452. Similarly, when the subject selection unit 108 receives the installation condition of the monitoring cameras along with the statistic information 451 and 452 from the statistic information transmission/reception unit 107, the subject selection unit 108 selects subject information according to the installation condition of the monitoring cameras and the statistic information 451 and 452.

The subject information transmission/reception unit 109 transmits subject information 561 selected in the video image monitoring system 100 to the video image monitoring system 110. When the video image monitoring system 110 receives the subject information 561, the video image monitoring system 110 outputs the subject information 561 to the subject identification unit 104 and performs identification processing of the subject.

The above is the configuration related to at least one embodiment of the present disclosure. With the configuration, it is possible to effectively and continuously perform tracking of a subject that has moved from a certain video image monitoring system 100 to another video image monitoring system 110. The number of the video image monitoring systems is not limited to two, but two or more video image monitoring systems may be communicably connected with each other through the network 20.

Information processing performed by the video image monitoring system 100 and the video image monitoring system 110 in the present embodiment will be described with reference to a flowchart shown in FIGS. 7A to 7C.

The information processing in the present embodiment is divided into three processing operations, which include subject tracking processing/subject information transmission processing, statistic information generation processing, and subject information reception/tracking processing.

First, the subject tracking processing/subject information transmission processing will be described.

### (Tracking Processing/Subject Information Transmission Processing)

FIG. 7A is a flowchart showing an example of the tracking processing/subject information transmission processing in the video image monitoring system 100.

In step S601, the video image acquisition unit 101 acquires a video image. The video image acquisition unit 101 may acquire a video image from an installed monitoring camera or may acquire a video image stored in a recorder. The video image acquisition unit 101 sends the acquired video image to the subject detection unit 102. After step S601, the processing proceeds to step S602.

In step S602, the subject detection unit 102 performs subject detection processing on the received video image. For example, the subject detection unit 102 performs the sliding window processing by using a human figure model prepared in advance to compare each area of an image with the human figure model, and detects an area whose similarity with the human figure model is higher than a set threshold value as a human figure. The subject detection unit 102 may detect a subject by using another method. The subject detection unit 102 sends a human figure detection result to the feature extraction unit 103. After step S602, the processing proceeds to step S603.

In step S603, the feature extraction unit 103 extracts a feature amount by using the human figure detection result. For example, the feature extraction unit 103 normalizes the human figure image detected by the subject detection unit 102 into a set size, divides the normalized human figure image into small areas, extracts a color histogram from each small area, and extracts a vector formed by connecting the histograms as a feature amount. The feature extraction unit 103 may extract the feature amount by using another feature extraction method. The feature extraction unit 103 sends the extracted feature amount to the subject identification unit 104. After step S603, the processing proceeds to step S604.

In step S604, the subject identification unit 104 identifies the same subject as the detected subject. For example, the subject identification unit 104 calculates a cosine similarity of a feature amount between a subject specified by a user and the obtained subject, determines a subject whose similarity is the highest as the same subject, and identifies the subject. The tracking processing is performed continuously on the identified subject. The subject identification unit 104 registers the identified subject information into the subject DB 105. After step S604, the processing proceeds to step S605.

In step S605, the statistic information transmission/reception unit 107 determines whether or not the subject being tracked has gone out of the monitoring space. When the subject is not detected in an image area of the monitoring camera in the video image monitoring system 100, the statistic information transmission/reception unit 107 determines that the subject has gone out of the monitoring space (has gone out of the imaging range of the monitoring camera). When the statistic information transmission/reception unit 107 determines that the subject has gone out of the monitoring space, the statistic information transmission/reception unit 107 advances the processing to step S606. When the statistic information transmission/reception unit 107 determines that the subject has not gone out of the monitoring space, the statistic information transmission/reception unit 107 ends the processing of the flowchart shown in FIG. 7A.

In step S606, the statistic information transmission/reception unit 107 requests the external video image monitoring system 110 to transmit statistic information and acquires the statistic information 451 and 452 from the video image monitoring system 110. When the statistic information transmission/reception unit 107 have received the statistic information, the statistic information transmission/reception unit 107 outputs the statistic information 451 and 452 to the subject selection unit 108. After step S606, the processing proceeds to step S607.

In step S607, the subject selection unit 108 selects subject information being tracked by using the statistic information 451 and 452 of each monitoring camera of the external video image monitoring system 110, which has been received from the statistic information transmission/reception unit 107. The subject selection unit 108 selects attributes of front-facing and right-facing subjects being tracked, whose statistical values are the highest in the statistic information 451 and 452, and creates and selects the subject information 561. The subject selection unit 108 outputs the selected subject information 561 to the subject information transmission/reception unit 109. After step S607, the processing proceeds to step S608. In step S608, the subject information transmission/reception unit 109 transmits the subject information 561 selected by the subject selection unit 108 to the external video image monitoring system 110.

The tracking processing in the video image monitoring system 110 will be described in <Subject Information Reception/Tracking Processing>.

When the subject information transmission/reception unit 109 completes transmission processing, the subject information transmission/reception unit 109 ends the processing of the flowchart shown in FIG. 7A.

The subject tracking processing/subject information transmission processing has been described. Subsequently, the statistic information generation processing will be described.

### (Statistical Information Generation Processing)

FIG. 7B is a flowchart showing an example of the statistic information generation processing in the video image monitoring system 110.

As Steps S601 to S603 are the same as the processing of FIG. 7A, the description thereof will not be repeated.

In step S614, the statistic information generation unit 106 generates statistic information related to a subject in the video image of the monitoring camera. For example, the statistic information generation unit 106 generates a histogram of class of a subject detection result of each of the video images 441 and 442 and defines the histograms as the statistic information 451 and 452. The statistic information generation unit 106 may generate the statistic information by using other information. After step S614, the processing proceeds to step S615.

In step S615, the statistic information transmission/reception unit 107 determines whether or not the statistic information transmission/reception unit 107 has received a transmission request for the statistic information 451 and 452 from the outside. For example, when the statistic information transmission/reception unit 107 of the video image monitoring system 110 has received the transmission request of the statistic information from the video image monitoring system 100, the statistic information transmission/reception unit 107 advances the processing to step S616. When the statistic information transmission/reception unit 107 has not received the transmission request, the statistic information transmission/reception unit 107 returns the processing to step S601.

In step S616, the statistic information transmission/reception unit 107 acquires the statistic information 451 and 452 generated by the statistic information generation unit 106 and transmits the statistic information 451 and 452 to the video image monitoring system 100 which is the transmission request source. When the statistic information transmission/reception unit 107 has transmitted the statistic information 451 and 452, the statistic information transmission/reception unit 107 ends the processing of the flowchart shown in FIG. 7B.

The statistic information generation processing has been described. Subsequently, the subject information reception/tracking processing in the monitoring system will be described.

### (Subject Information Reception/Tracking Processing)

FIG. 7C is a flowchart showing an example of the subject information reception/tracking processing.

As Steps S601 to S603 are the same as the processing of FIG. 7A, the description thereof will not be repeated. In step S624, the subject information transmission/reception unit 109 of the video image monitoring system 110 determines whether or not the subject information transmission/reception unit 109 has received the subject information 561 from an outside monitoring system. When the subject information transmission/reception unit 109 has not received the subject information 561 from the outside, the subject information transmission/reception unit 109 ends the processing of the flowchart of FIG. 7C. When the subject information transmission/reception unit 109 has received the subject information 561 from the outside, the subject information transmission/reception unit 109 sends the subject information to the subject identification unit 104 and proceeds to step S625.

In step S625, the subject identification unit 104 performs identification processing with a human figure detected in the video image monitoring system 110 by using the received subject information 561, and tracks a subject. The subject identification unit 104 calculates a similarity between a feature amount of the subject information 561 and a feature amount obtained from the feature extraction unit 103, identifies a subject with the highest similarity as the same human figure as that of the subject information 561, and performs tracking. When the similarity is smaller than or equal to a set value, the subject identification unit 104 determines that the subject cannot be identified and does not perform tracking. When the subject identification unit 104 has identified the subject, the subject identification unit 104 stores an identification result including the statistic information of the identified subject into the subject DB 105. Further, the subject identification unit 104 transmits a tracking request of the identified subject to the video image monitoring system 110, and ends the processing of the flowchart shown in FIG. 7C.

The above is the subject information reception/tracking processing.

With the processing, it is possible to easily and continuously perform tracking in the video image monitoring system 110 while reducing communication cost by selecting subject information of the subject being tracked in the video image monitoring system 100 and transmitting the subject information from the video image monitoring system 100 to the video image monitoring system 110.

### Second Embodiment

The statistic information generation unit 106 also generates statistic information indicating a monitoring camera of the video image monitoring system 100 from which a subject has gone out to the outside and a monitoring camera of the video image monitoring system 101 where the subject appears, on the basis of the subject information stored in the subject DB 105.

For this purpose, the subject information transmission/reception unit 109 of the video image monitoring system 100 transmits the subject information to the video image monitoring system 110 along with a camera ID of a subject that is identified most recently. The subject information transmission/reception unit 109 of the video image monitoring system 110 stores the received subject information into the subject DB 105 along with a camera ID identified first by the subject identification unit 104.

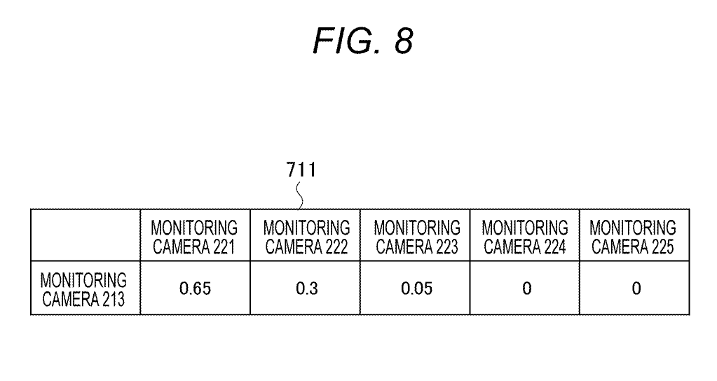

The statistic information generation unit 106 acquires, from the subject DB 105, subject information that has been identified/tracked between the video image monitoring system 100 and the video image monitoring system 110. Then, the statistic information generation unit 106 generates a probability that a subject goes out to the outside from the monitoring camera of the video image monitoring system 100 and appears in the monitoring camera of the video image monitoring system 110, as the statistic information, on the basis of relation of registered camera IDs. FIG. 8 is a diagram showing an example in which the statistic information generation unit 106 calculates a probability that a subject goes out to the outside from the monitoring camera 213 and appears in any one of the monitoring cameras 221 to 225, as statistic information 711. The statistic information generation unit 106 does not calculate the probability only for the monitoring camera 213, but calculates the probability also for the other monitoring cameras.

Further, the statistic information generation unit 106 calculates a moving time of a subject between the video image monitoring systems 100 and 110 on the basis of a time when the subject is identified most recently in the video image monitoring system 100 and a time when the subject is first identified in the video image monitoring system 110, on the basis of information of the subject ID registered in the subject DB 105. The statistic information generation unit 106 may calculate the moving time from a difference between a time when the subject disappears and the current time, and select statistic information of a monitoring camera according to the calculated moving time. The statistic information generation unit 106 outputs generated statistic information 451, 452, and 711 to the statistic information transmission/reception unit 107. The statistic information transmission/reception unit 107 transmits the statistic information 451, 452, and 711 to the video image monitoring system 100. When the statistic information transmission/reception unit 107 receives the statistic information 451, 452, and 711 and the moving time from the statistic information generation unit 106, the statistic information transmission/reception unit 107 may transmits the statistic information 451, 452, and 711 and the moving time to the video image monitoring system 100.

The statistic information transmission/reception unit 107 of the video image monitoring system 100 receives the statistic information 451, 452, and 711 from the video image monitoring system 110 and outputs the received information to the subject selection unit 108.

The subject selection unit 108 selects the subject information being tracked by using the statistic information 451, 452, and 711. At this time, the subject selection unit 108 selects the statistic information 451 and 452 of the monitoring camera where the appearance probability of the statistic information 711 is greater than or equal to a threshold value, and selects subject information with similar attribute. Alternatively, when a value obtained by multiplying each statistical value of the statistic information 451 and 452 of each monitoring camera by the statistic information 711 between the monitoring cameras is greater than or equal to a threshold value, the subject selection unit 108 may select subject information of its detection class.

The subject selection unit 108 outputs the selected subject information to the subject information transmission/reception unit 109. The subject information transmission/reception unit 109 transmits the received subject information to the external video image monitoring system 110.

Thus, it is possible to select the information of a subject when it appears, thereby, reducing the amount of information to be transmitted.

Information processing performed by the video image monitoring system 100 and the video image monitoring system 110 of the present embodiment will be described with reference to the flowchart shown in FIGS. 7A to 7C.

### (Tracking Processing/Subject Information Transmission Processing)

In step S607, the subject selection unit 108 selects subject information being tracked by using the statistic information 451 and 452 received from the statistic information transmission/reception unit 107 and the statistic information 711. In this step, the subject selection unit 108 selects the statistic information 451 of the monitoring camera where the appearance probability of the statistic information 711 is greater than or equal to a threshold value, and creates and selects subject information with similar attribute. The subject selection unit 108 outputs the selected subject information to the subject information transmission/reception unit 109. After step S607, the processing proceeds to step S608.

### (Statistical Information Generation Processing)

In step S614, the statistic information generation unit 106 generates the statistic information 711 related to between the monitoring cameras in addition to the statistic information 451 and 452. The statistic information generation unit 106 extracts a camera ID that is identified most recently in the video image monitoring system 100 and a camera ID that is first identified and registered in the video image monitoring system 110. The statistic information generation unit 106 generates the statistic information 711 of a subject identified between the monitoring cameras on the basis of the extracted camera IDs.

Further, the statistic information generation unit 106 may calculate the moving time between the monitoring systems on the basis of the subject information registered in the subject DB 105, and select the statistic information 451 and 452 according to the moving time. After the statistic information generation unit 106 generates the statistic information 451, 452, and 711, the statistic information generation unit 106 advances the processing to step S615.

The above is the information processing according to the present embodiment.

With the processing, it is possible to more accurately select the feature amount of the subject by using the appearance probability related to the moving of the subject between the monitoring systems as the statistic information. Although the subject is a human figure in the description of the present embodiment, the subject may be another object.

### Other Embodiments

In at least one embodiment of the present disclosure, a program that realizes one or more functions of the embodiments described above is supplied to a system or an apparatus through a network or a storage medium. One or more embodiments of the present disclosure can also be realized by processing where one or more processors in the system or the apparatus read and execute the program. Further, one or more embodiments of the present disclosure can also be realized by a circuit (for example, ASIC) that realizes one or more functions.

While an example of each of the embodiments of the present disclosure has been described in detail, the present disclosure is not limited to the specific embodiments. The functional configuration of the video image monitoring system may partially or entirely be mounted on the video image monitoring system as a hardware configuration. As the hardware configuration of the video image monitoring system, more than one CPUs, ROMs, RAMS, HDDs, NICs, and the like may be used. A plurality of CPUs may realize the function and the like of the video image monitoring system by executing processing while using data and the like stored in a plurality of RAMS, ROMs, and HDDs on the basis of a program. Further, a GPU (Graphics Processing Unit) may be used instead of the CPU.

According to the processing of each embodiment described above, it is possible to track the subject even in different video image monitoring systems while reducing communication cost.

According to one or more embodiments of the present disclosure, it is possible to easily track the subject even in different video image monitoring systems while reducing communication cost.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-087205, filed Apr. 26, 2017, which is hereby incorporated by reference herein in its entirety.

What is claimed is:

1. An information processing device comprising:
a detection unit configured to detect a subject on a captured image that is acquired from at least one or more image capturing units;
an acquisition unit configured to acquire feature information corresponding to a subject detected by an external device from the external device when the subject being detected by the detection unit becomes undetected on a captured image that is newly acquired by the at least one or more image capturing units;
an identification unit configured to identify that the subject detected by the detection unit is the subject indicated by the feature information acquired by the acquisition unit; and
a transmission unit configured to transmit information indicating a feature of the subject identified by the identification unit to the external device.

2. The information processing device according to claim 1, wherein the transmission unit transmits tracking of the subject identified by the identification unit to the external device.

3. A video image monitoring system comprising:
a first system configured to monitor a video image of a first camera group; and
a second system configured to monitor a video image of a second camera group,
wherein the first system includes:
an acquisition unit configured to acquire, from the second system, statistic information of a subject included in the video image of the second camera group when a subject being tracked on a basis of the video image of the first camera group becomes undetected from the video image of the first camera group,
a selection unit configured to select subject information of a subject on a basis of the statistic information acquired by the acquisition unit, and
a first transmission unit configured to transmit the subject information selected by the selection unit to the second system.

4. The video image monitoring system according to claim 3,
wherein the second system includes:
a generation unit configured to generate the statistic information of the subject included in the video image of the second camera group, and
a second transmission unit configured to transmit the statistic information generated by the generation unit to the first system when receiving a transmission request of the statistic information from the first system.

5. The video image monitoring system according to claim 3,
wherein the second system further includes:
an execution unit configured to execute identification processing on a basis of the subject information received from the first system and subject information of a plurality of subjects detected from the video image of the second camera group when receiving the subject information from the first system.

6. A video image monitoring system that monitors a video image of a first camera, the video image monitoring system comprising:
an acquisition unit configured to acquire information of a subject included in a video image of a second camera when a subject being tracked on a basis of the video image of the first camera goes out of an imaging range of the first camera; and
a transmission unit configured to transmit subject information selected on a basis of the information acquired by the acquisition unit to an outside of the video image monitoring system.

7. The video image monitoring system according to claim 6, wherein the information includes statistic information related to an attribute of a subject.

8. The video image monitoring system according to claim 7,
wherein the information further includes an appearance probability of a subject in the second camera, and
the transmission unit transmits subject information based on an attribute of a subject included in a video image of the second camera where the appearance probability is greater than or equal to a set value.

9. The video image monitoring system according to claim 7, wherein the attribute of the subject is an orientation of the subject.

10. The video image monitoring system according to claim 9, wherein the attribute of the subject is an orientation of the subject for each age.

11. The video image monitoring system according to claim 9, wherein the attribute of the subject is an orientation of the subject for each gender.

12. An information processing method comprising:
detecting a subject on a captured image that is acquired from at least one or more image capturing devices;
acquiring feature information corresponding to a subject detected by an external device from the external device when the subject being detected by the detecting becomes undetected on a captured image that is newly acquired by the at least one or more image capturing devices;
identifying that the subject detected in the detecting is the subject indicated by the feature information acquired in the acquiring; and
transmitting information indicating a feature of the subject identified in the identifying to the external device.

13. An information processing method performed by a system that monitors a video image of a first camera, the information processing method comprising:
acquiring information of a subject included in a video image of a second camera when a subject being tracked on a basis of the video image of the first camera goes out of an imaging range of the first camera; and
transmitting subject information selected on a basis of the information acquired by the acquiring to an outside of the system.

14. A recording medium that stores at least one program for causing a computer to execute the information processing method, the information processing method comprising:
detecting a subject on a captured image that is acquired from at least one or more image capturing devices;
acquiring feature information corresponding to a subject detected by an external device from the external device when the subject being detected by the detecting becomes undetected on a captured image that is newly acquired by the at least one or more image capturing devices;
identifying that the subject detected in the detecting is the subject indicated by the feature information acquired in the acquiring; and
transmitting information indicating a feature of the subject identified in the identifying to the external device.
